(19) United States
(12) Patent Application Publication
(10) Pub. No.: US 2009/0049134 A1
(43) Pub. Date: Feb. 19, 2009

(54) METHOD FOR DELAYING DELIVERY OF E-MAIL CONTENT

(76) Inventors: David Bruce Kumhyr, Austin, TX (US); Pamela Ann Nesbitt, Tampa, FL (US)

Correspondence Address: IBM CORP (YA);C/O YEE & ASSOCIATES PC, P.O. BOX 802333, DALLAS, TX, 75380, US

(21) Appl. No.: 11/839,664

(22) Filed: Aug. 16, 2007

(51) Int. Cl. G06F 15/16

(52) U.S. Cl. 709/206

(57) ABSTRACT

A computer implemented method, data processing system, and computer program product for managing the delivery of an electronic mail (e-mail) message, and for delaying the delivery of the e-mail message until a time in which the e-mail recipient is present to act upon the message. When a request is received from a sender to send an e-mail message to a recipient, a proxy e-mail message is generated which comprises a reference to the e-mail message. The proxy e-mail message is then sent to the recipient. When a notification from the recipient that the proxy e-mail message has been opened is received, the e-mail message is then sent to the recipient.

### BACKGROUND OF THE INVENTION

1. Field of the Invention

The present invention relates generally to an improved data processing system, and in particular to a method for managing the delivery of the content of an electronic mail (e-mail) message, and for delaying the delivery of the e-mail message until a time in which the e-mail recipient is present to act upon the message.

2. Description of the Related Art

The Internet is a global network of computers and networks joined together by gateways that handle data transfer and the conversion of messages from a protocol of a sending network to a protocol used by a receiving network. On the Internet, any computer may communicate with any other computer. Information between computers travels over the Internet through a variety of languages also referred to as protocols. The set of protocols used on the Internet is called the Transmission Control Protocol/Internet Protocol (TCP/IP).

The Internet has revolutionized communications and commerce as well as being a source of information and entertainment. For many users, e-mail is a widely used format to communicate over the Internet. It is commonplace for users to send e-mail messages to others users through the Internet.

The use of e-mail messages is commonplace for personal and business use. E-mail messages are used by individuals to keep in touch with and communicate with other users. Additionally, e-mail messages provide a medium to collaborate and exchange documents.

While e-mail allows individuals to communicate with others, there are some situations where a user discovers an error in the e-mail message. In these situations, the user may want to “unsend” the message. However, in existing e-mail systems, after a user sends an e-mail message to a recipient, the user cannot recall or prevent the e-mail message from being downloaded at the recipient's e-mail client. Thus, a user does not have any control over an e-mail message once the user sends the e-mail message to another user.

Consequently, it would be advantageous to have an e-mail messaging system which allows an e-mail sender to recall or pull-back an e-mail message after the e-mail message has been sent to a recipient.

### SUMMARY OF THE INVENTION

The illustrative embodiments provide a computer implemented method, data processing system, and computer program product for managing the delivery of an e-mail message, and for delaying the delivery of the e-mail message until a time in which the e-mail recipient is present to act upon the message. When a request is received from a sender to send an e-mail message to a recipient, a proxy e-mail message is generated which comprises a reference to the e-mail message. The proxy e-mail message is then sent to the recipient. When a notification from the recipient that the proxy e-mail message has been opened is received, the e-mail message is then sent to the recipient.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the illustrative embodiments may be implemented;

FIG. 2 is a block diagram of a data processing system in which the illustrative embodiments may be implemented;

FIG. 3 is a block diagram of an exemplary e-mail system in which the illustrative embodiments may be implemented; and

FIG. 4 is a flowchart of a process for delaying the delivery of the content of an e-mail message in accordance with the illustrative embodiments.

### DETAILED DESCRIPTION OF THE PREFERRED EMBODIMENT

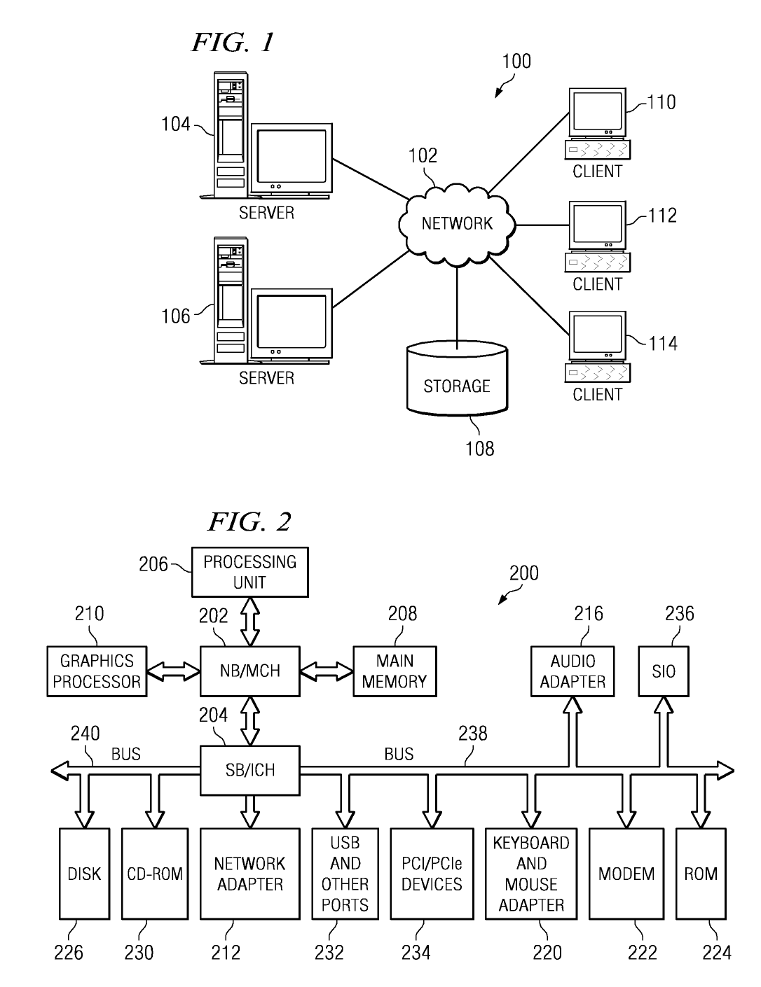

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a mechanism which delays dispatching an e-mail message to a recipient until the recipient of the e-mail message is able to act on the e-mail. When a sender creates an e-mail message to be sent to a recipient, the e-mail message is stored at either the sender's local drive or on the sender's local server. With the illustrative embodiments, instead of having the e-mail message (stored at either the sender's local drive or on the sender's local e-mail server) dispatched to the recipient e-mail client, the sender e-mail client delays the dispatch of the e-mail message to the recipient by first generating a proxy e-mail for the e-mail message. This proxy e-mail comprises a reference to the actual e-mail message created by the sender. The reference may include a link which points to the location on the sender's local drive or local e-mail server in which the actual e-mail message is stored. The proxy e-mail message is then dispatched to the recipient e-mail client.

When the recipient e-mail client receives and opens the proxy e-mail message, a receipt option on the recipient e-mail client generates a receipt notification. This receipt notification of the proxy e-mail message, in addition to the reference to the actual e-mail message, is returned to the sender e-mail client. The sender e-mail client scans the receipt notification and, using the reference to the actual e-mail message returned with the receipt notification, locates the actual e-mail message on the sender's local drive or on the sender's local e-mail server. In one embodiment, the sender e-mail client may automatically dispatch the actual e-mail message to the recipient e-mail client upon receiving the receipt notification. In another embodiment, the sender e-mail client may require approval that the sender still desires the actual e-mail message to be sent to the recipient. For instance, a sender may not want the actual e-mail message to be sent to a recipient if there is a time component to the e-mail message which has elapsed, of if the sender (for whatever reason) no longer wants the recipient to view the actual e-mail message. In this case, the sender e-mail client prompts the sender to give approval to send the actual e-mail message to the recipient. Once the sender e-mail client receives the approval, the e-mail client dispatches the actual e-mail message to the recipient e-mail client.

As previously mentioned, current e-mail systems do not allow for recalling or deleting an e-mail message once the message is sent. A sender may desire to recall or delete an e-mail message in various situations. In the first situation, the sender may determine that the e-mail message contains an error, such as carbon copying the wrong recipients or too many recipients, leaving the thread of e-mail attached which was not intended to be viewed by other recipients, forgetting to remove the large attachments to people who use dial-up, using the wrong form of address, etc. In addition, the sender may have written the e-mail message under certain circumstances (e.g., when the user was angry), and the user now does not want the recipient to receive the message.

A second situation in which a sender may also want to delay dispatching an e-mail message is when a user sends an offer or terms in the message. By sending the e-mail message only when the recipient is present and available to act on the message content, the sender may possibly obtain a better price or terms than if the e-mail message was delivered earlier. In a third situation, a sender may want to delay sending an e-mail message until the recipient is present to act upon the message to prevent confidential information in an e-mail message from sitting on the recipient's server or e-mail client inbox. In a fourth situation, it is also desirable to allow a sender to recall or delete the message when an e-mail message is sent to multiple recipients. For instance, if an urgent e-mail message is sent to multiple recipients requesting an action be taken by any one of the recipients, once the first recipient of the message acts on the message, the sender may want to recall or delete the e-mail message for the remaining recipients to avoid confusion and duplicate work.

Thus, the illustrative embodiments provide a mechanism which effectively delays the actual transmission of an e-mail message until the recipient opens the proxy e-mail message. Until the recipient opens the proxy e-mail message, the actual e-mail message is still accessible by the sender e-mail client and can be edited or deleted. If the sender e-mail client deletes the actual e-mail message, the proxy e-mail message at that point would become invalid. In this manner, the illustrative embodiments provide a solution which allows a sender in the first situation above to retract the e-mail message by deleting the original message. The illustrative embodiments also allow a sender in the second and third situations above to delay sending the actual e-mail message until the recipient opens the proxy e-mail message, or to retract the actual e-mail message due to a better offer or second thoughts by the sender. For the fourth situation above, the illustrative embodiments allow the first occurrence of the proxy e-mail message being opened (which activates sending the actual e-mail message to that particular recipient) to cause deletion of the actual e-mail message or flagging the actual e-mail message as “not sendable”, thus invalidating the proxy e-mail messages sent to all of the other recipients.

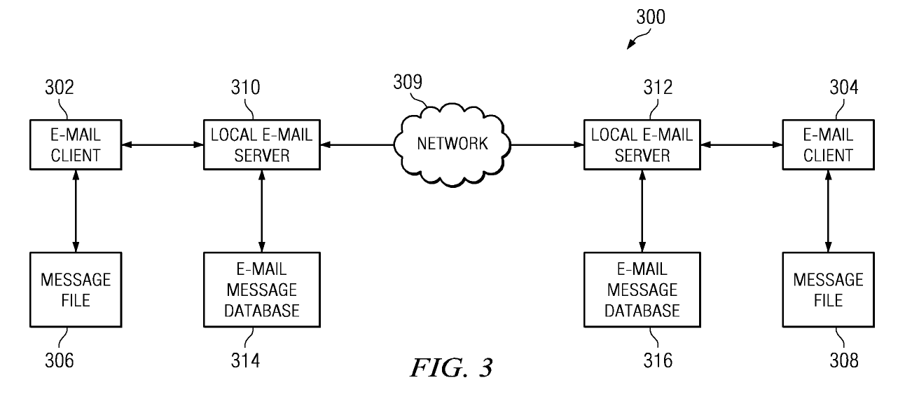

Turning now to FIG. 3, a diagram illustrating an e-mail messaging system is depicted in accordance with an illustrative embodiment. In this example, e-mail messaging system 300 includes e-mail client 302 and e-mail client 304, which are programs or applications located at different client data processing systems, such as client 110, client 112, or client 114 in FIG. 1. Message file 306 and message file 308 are associated with these e-mail clients. These message files store e-mail messages received by the clients and may be organized into various mailboxes. Examples of various mailboxes include, for example, an inbox folder, a sent folder, a deleted folder, and an outbox folder.

These e-mail programs may employ different protocols depending upon the implementation. For example, simple mail transfer protocol (SMTP) is a standard e-mail protocol that is based on TCP/IP. This protocol defines a message format and the message transfer agent which stores and forwards the mail. Other protocols, such as post office protocol 3 (POP3), also may be employed.

These e-mail programs are used to send e-mails back and forth via network 309 to different users through local e-mail servers 310 and 312. Message database 314 and message database 316 are associated with these e-mail servers. These message databases store e-mail messages sent to other e-mail clients and e-mail messages received by other e-mail clients. For example, when e-mail client 304 connects to its local e-mail server 312, any messages intended for e-mail client 304 which are stored on its local e-mail server 312 are then sent to e-mail client 304.

E-mail clients 302 and 304 may be implemented using presently available e-mail clients. The delay mechanism described in illustrative embodiments only requires changes to be made to the client side (e.g., e-mail clients 302 and 304) of the e-mail system. For instance, an e-mail client is modified to be able to generate a proxy e-mail message from an actual e-mail message. When a user wants to send the actual e-mail to a recipient, this proxy e-mail message is initially sent as a replacement to the actual e-mail. The e-mail client is also modified to retain the actual e-mail message on either the sending e-mail client's local drive or the sending e-mail client's local server (depending upon the particular e-mail system implementation), rather than dispatching the actual e-mail message to the recipient e-mail client. Thus, the actual e-mail message is initially not dispatched to the recipient e-mail client or the recipient's local server. The actual e-mail message is only dispatched to the recipient e-mail client when the recipient is present and acting on the proxy e-mail message. For example, the sending e-mail client may determine that the recipient is present and acting on the proxy e-mail message when the sending e-mail client receives a receipt notification from the recipient e-mail client which indicates that the recipient has opened the proxy e-mail message. Thus, the recipient e-mail client should also be modified to send receipt notifications when an e-mail message is read or opened by the recipient.

When the sender e-mail client receives a receipt notification, the sender e-mail client may automatically dispatch the actual e-mail message to the recipient e-mail client. Alternatively, the sender e-mail client may require approval that the sender still desires the actual e-mail message to be sent to the recipient. In this case, the sender e-mail client prompts the sender for approval to send the actual e-mail message now that the recipient is present and available to act on the e-mail message. When the sender e-mail client receives an approval from the sender, the sender e-mail client dispatches the actual e-mail message to the recipient e-mail client.

In situations where the receipt notification option is not enabled on the recipient e-mail client, the proxy e-mail message may contain a request that the recipient send a reply e-mail message to request the actual e-mail message from the sender. When the sender e-mail client receives the reply e-mail message, the sender e-mail client scans the reply e-mail message and uses the reference to the actual e-mail message returned with the reply e-mail message to locate the actual e-mail message on the sender's local drive or on the sender's local server.

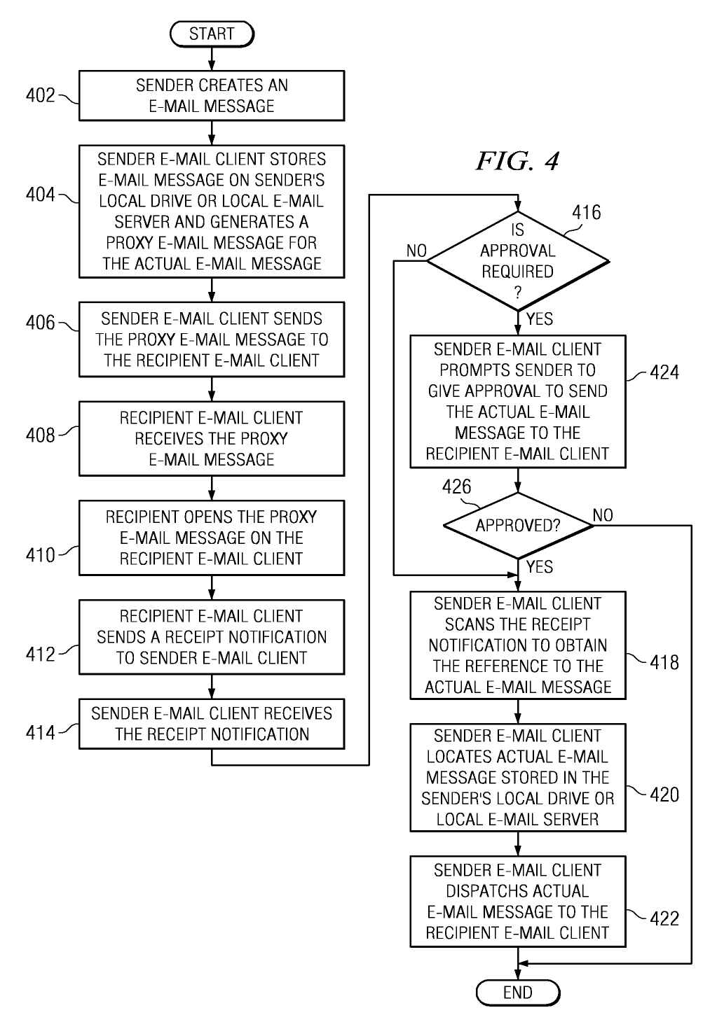

FIG. 4 is a flowchart of a process for delaying the delivery of the content of an e-mail message in accordance with the illustrative embodiments. The process begins when a sender creates an actual e-mail message using the sender e-mail client (step 402). When the sender attempts to send the actual e-mail message, the sender e-mail client stores the actual e-mail message on one of the sender's local drive or the sender's local server and generates a proxy e-mail message for the actual e-mail message (step 404). The proxy e-mail message does not contain the content of the actual e-mail message, but rather comprises a reference to the actual e-mail message stored on the sender's local drive or local server.

The sender e-mail client then sends the proxy e-mail message to the recipient e-mail client (step 406). It should be noted that the actual e-mail message is not dispatched to the recipient e-mail client or the recipient local e-mail server at this point. The recipient e-mail client then receives the proxy e-mail (step 408).

When the recipient opens the proxy e-mail on the recipient e-mail client (step 410), the recipient e-mail client sends a receipt notification to the sender e-mail client (step 412). The receipt notification comprises the reference to the actual e-mail message stored in the sender's local drive or local e-mail server. In an alternative embodiment, if the receipt notification option is not enabled on the recipient e-mail client, the proxy e-mail message may contain a request for the recipient to reply to the proxy e-mail message. When the recipient replies to the proxy e-mail message, the reply e-mail message will include the reference to the actual e-mail message similar to the receipt notification.

When the sender e-mail client receives the receipt notification (or the reply e-mail message) (step 414), the sender e-mail client may determine if approval is required before dispatching the actual e-mail message referenced in the receipt notification or the reply e-mail message (step 416). If no approval is required (‘no’ output of step 416), the sender e-mail client scans the receipt notification (or the reply e-mail message) to obtain the reference to the actual e-mail message (step 418), locates the actual e-mail message stored in the sender's local drive or local e-mail server (step 420), and dispatches the actual e-mail message to the recipient e-mail client (step 422), with the process terminating thereafter.

Turning back to step 416, if approval is required (‘yes’ output of step 416), the sender e-mail client prompts the sender to give approval to send the actual e-mail message to the recipient e-mail client (step 424). A determination is then made as to whether the sender has provided approval (step 426). If the sender has provided approval (‘yes’ output of step 426), the sender e-mail client scans the receipt notification or the reply e-mail message to obtain the reference to the actual e-mail message (step 418), locates the actual e-mail message stored in the sender's local drive or local e-mail server (step 420), and dispatches the actual e-mail message to the recipient e-mail client (step 422), with the process terminating thereafter.

Turning back to step 426, if the sender has not provided approval (‘no’ output of step 426), the process terminates thereafter.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing delivery of an electronic mail message, the computer implemented method comprising:
responsive to receiving a request from a sender to send an electronic mail message to a recipient, generating a proxy electronic mail message comprising a reference to the electronic mail message;
sending the proxy electronic mail message to the recipient;
receiving a notification from the recipient that the proxy electronic mail message has been opened; and
responsive to receiving the notification, sending the electronic mail message to the recipient.

2. The computer implemented method of claim 1, wherein sending the electronic mail message further comprises:
scanning the notification to obtain the reference to the electronic mail message;
locating the electronic mail message using the notification; and
sending the located electronic mail message to the recipient.

3. The computer implemented method of claim 1, further comprising:
responsive to receiving a notification from the recipient that the proxy electronic mail message has been opened, requesting approval from the sender to send the electronic mail message to the recipient; and
responsive to receiving approval from the sender, sending the electronic mail message to the recipient.

4. The computer implemented method of claim 1, further comprising:
responsive to sending the proxy electronic mail message to a plurality of recipients, receiving a notification from a first recipient that the proxy electronic mail message has been opened; and
invalidating the proxy electronic mail message sent to other recipients in the plurality of recipients by one of deleting the electronic mail message or flagging the electronic mail message as ‘not sendable’.

5. The computer implemented method of claim 1, wherein the electronic mail message is stored at only the local drive or local electronic mail server of the sender until the notification is received from the recipient.

6. The computer implemented method of claim 1, wherein the reference is a link to the electronic mail message.

7. The computer implemented method of claim 1, wherein the notification is a receipt notification.

8. The computer implemented method of claim 7, wherein the receipt notification comprises the reference to the electronic mail message.

9. The computer implemented method of claim 1, wherein the notification is a reply electronic mail message.

10. The computer implemented method of claim 9, wherein the reply electronic mail message comprises the reference to the electronic mail message.

11. A data processing system for managing delivery of an electronic mail message, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to generate, in response to receiving a request from a sender to send an electronic mail message to a recipient, a proxy electronic mail message comprising a reference to the electronic mail message; send the proxy electronic mail message to the recipient; receive a notification from the recipient that the proxy electronic mail message has been opened; and send the electronic mail message to the recipient in response to receiving the notification.

12. A computer program product for managing delivery of an electronic mail message, the computer program product comprising:
a computer usable medium having computer usable program code tangibly embodied thereon, the computer usable program code comprising:
computer usable program code for generating, in response to receiving a request from a sender to send an electronic mail message to a recipient, a proxy electronic mail message comprising a reference to the electronic mail message;
computer usable program code for sending the proxy electronic mail message to the recipient;
computer usable program code for receiving a notification from the recipient that the proxy electronic mail message has been opened; and
computer usable program code for sending the electronic mail message to the recipient in response to receiving the notification.

13. The computer program product of claim 12, wherein the computer usable program code for sending the electronic mail message further comprises:
computer usable program code for scanning the notification to obtain the reference to the electronic mail message;
computer usable program code for locating the electronic mail message using the notification; and
computer usable program code for sending the located electronic mail message to the recipient.

14. The computer program product of claim 12, further comprising:
computer usable program code for requesting approval from the sender to send the electronic mail message to the recipient in response to receiving a notification from the recipient that the proxy electronic mail message has been opened; and
computer usable program code for sending the electronic mail message to the recipient in response to receiving approval from the sender.

15. The computer program product of claim 12, further comprising:
computer usable program code for receiving, in response to sending the proxy electronic mail message to a plurality of recipients, a notification from a first recipient that the proxy electronic mail message has been opened; and
computer usable program code for invalidating the proxy electronic mail message sent to other recipients in the plurality of recipients by one of deleting the electronic mail message or flagging the electronic mail message as ‘not sendable’.

16. The computer program product of claim 12, wherein the electronic mail message is stored at only the local drive or local electronic mail server of the sender until the notification is received from the recipient.

17. The computer program product of claim 12, wherein the reference is a link to the electronic mail message.

18. The computer program product of claim 12, wherein the notification is a receipt notification, and wherein the receipt notification comprises the reference to the electronic mail message.

19. The computer program product of claim 12, wherein the notification is a reply electronic mail message, and wherein the reply electronic mail message comprises the reference to the electronic mail message.
